(19) United States
(12) Patent Application Publication
(10) Pub. No.: US 2008/0216323 A1
(43) Pub. Date: Sep. 11, 2008

(54) SHAVING PREPARATION DELIVERY SYSTEM FOR WET SHAVING SYSTEM

(75) Inventors: Raymond Guimont, Guilford, CT (US); Rooma Mehta, Guilford, CT (US); Robert McCormack, Orange, CT (US); James Smith, Montclair, NJ (US)

Correspondence Address: MICHAUD-DUFFY GROUP LLP, 306 INDUSTRIAL PARK ROAD, SUITE 206, MIDDLETOWN, CT, 06457, US

(73) Assignee: EVEREADY BATTERY COMPANY, INC., St. Louis, MO (US)

(21) Appl. No.: 12/044,012

(22) Filed: Mar. 7, 2008

Related U.S. Application Data
(60) Provisional application No. 60/906,141, filed on Mar. 9, 2007.
(60) Provisional application No. 60/906,110, filed on Mar. 9, 2007.

(51) Int. Cl. B26B 19/38; B26B 21/52; B26B 21/40

(52) U.S. Cl. 30/41.5; 30/41; 30/526; 30/537

(57) ABSTRACT

A wet shave razor assembly includes a shaving aid delivery system surrounding a razor cartridge. The shaving aid delivery system includes a hydrophilic foam having a water soluble shaving preparation disposed therein. During a wet shave operation, the hydrophilic foam is compressed as the razor is stroked across a user's skin. The hydrophilic foam is an open-cell structure defined by a plurality of supporting elements that cooperate to form tortuous paths. The hydrophilic foam can also include closed cells, or it can be a combination of open cells and closed cells. The shaving preparation is disposed in the paths and/or closed cells. A combination razor cartridge/shaving aid delivery system assembly can be releasably attached to a handle. The razor cartridge may be movable relative to the hydrophilic foam and include a mechanism allowing such movement housed in the handle, or it can be fixed relative to the hydrophilic foam.

### CROSS REFERENCE TO RELATED APPLICATIONS

This application is entitled to the benefit of and incorporates by reference the disclosure of U.S. Provisional Patent Application Ser. No. 60/906,141 filed on Mar. 9, 2007. This application is related to U.S. Provisional Patent Application Ser. No. 60/906,110, filed on Mar. 9, 2007, the disclosure of which is incorporated by reference herein in its entirety.

### TECHNICAL FIELD

This invention relates generally to wet shaving systems and, more particularly, to a mechanism for delivering shaving aid material to a user's skin during a shaving operation.

### BACKGROUND

Conventional shaving devices that simultaneously apply a shaving preparation and remove hair typically include a removable cartridge and a comfort strip having shaving preparation impregnated therein mounted on a skin-contacting surface of the cartridge. As the razor cartridge is stroked over a user's skin, the shaving aid material is released from the comfort strip onto the user's skin. A difficulty associated with the use of comfort strips is that there is insufficient shaving aid material contained therein to provide, for example, adequate lubricity to the user's skin when shaving large surface areas such as a person's legs.

Based on the foregoing, it is a general object of the present invention to provide a razor assembly usable in a wet shaving environment that is capable of providing a sustained, consistent release of shaving preparation material to a skin surface during a shaving operation that improves upon the prior art.

### SUMMARY OF THE INVENTION

In one aspect, the present invention is directed to a wet shave razor assembly that includes a shaving aid delivery system surrounding a razor cartridge. The shaving aid delivery system includes a hydrophilic foam having a water soluble shaving preparation disposed therein. Preferably, the hydrophilic foam defines a central aperture extending at least part way through the hydrophilic foam surface. The central aperture is sized to receive the razor cartridge therein. During a wet shave operation, the hydrophilic foam is compressed as the razor is stroked across a user's skin. The compression of the foam in the wet-shave environment causes the shaving aid material disposed within the foam to be controllably released onto the user's skin. Preferably, the razor cartridge can pivot about an axis extending in a lengthwise direction of the razor cartridge. However, the present invention is not limited in this regard as the razor cartridge can also be non-pivotable. It is also preferable that the razor cartridge is movable relative to the hydrophilic foam to allow the foam to be sufficiently compressed to cause the shaving preparation to be dispensed. However, the present invention is not limited in this regard as the hydrophilic foam can also extend past the razor cartridge so that it must be compressed to allow the cutting edges of the razor blades to contact a user's skin during a shaving operation.

In another aspect, the hydrophilic foam is defined by a plurality of supporting elements in the form of walls or struts that cooperate to define tortuous paths. The shaving preparation is disposed in these tortuous paths. In the preferred embodiment of the present invention, the shaving preparation material is water-soluble. The hydrophilic foam pad can be produced as a hydrolyzed reaction product of a polyol, a polyoxyethylene diol, and an isocyante and such that shaving preparation material is incorporated into the foam. The hydrophilic foam can comprise open cells or closed cells, or it can be a combination of open cells and closed cells.

In another aspect, the present invention is directed to a shaving preparation delivery system defined by a foam pad having a central aperture and a contact surface and a water soluble shaving preparation material disposed in the foam pad. The foam pad can be a replacement pad that is mountable on one of a base forming part of a replacement cartridge and a handle. When the foam pad is mounted on either the razor cartridge or the handle, pressure exerted on the foam pad (e.g., by pressing or stroking the pad against the surface to be shaved in a shaving operation) causes the shaving preparation to be dispelled from the contact surface onto a user's skin.

The present invention can also be embodied in a cartridge/shaving aid delivery system assembly that can be releasably attached to a handle. Alternately, the shaving aid delivery system and the razor cartridge can each be separately and releasably attachable to a handle. In addition, where the razor cartridge is movable relative to the hydrophilic foam, the mechanism allowing such movement can be housed in the handle with the razor cartridge being releasably attachable to the mechanism.

One advantage of using the above-described hydrophilic foams for delivering shaving preparation is that a sustained release of shaving preparation material can be realized during a shaving operation. Because of the hydrophilic nature of the foam, the shaving preparation material incorporated therein can be controllably solubilized and released in response to the needs of the user during a shaving operation.

Another advantage of using the above-described hydrophilic foams is that the durability and dimensional stability of the foam structure allows for an extended number of shaves to be achieved without substantial degradation of the foam. More specifically, the material from which the foam is manufactured and the particular configuration of the cell structure of the foam allows the foam to maintain its structural integrity by, for example, inhibiting the collapse of the cell structure during use. By inhibiting collapse of the cells, shaving preparations (lubricants or the like) can be more efficiently and sufficiently expelled from the foam throughout the useful life of the device into which the foam is incorporated. The wear issues that are normally associated with soap-based shaving aid materials are also avoided.

### BRIEF DESCRIPTION OF THE DRAWINGS

FIG. 1 is perspective view of a foam pad for a razor assembly of the present invention.

FIG. 2 is a cross-sectional representation of the foam pad of FIG. 1.

FIG. 3 is a cross-sectional representation of the foam in which shaving preparation material is trapped in the open-cell structure thereof.

FIG. 4 is a cross-sectional representation of the foam in which shaving preparation material is trapped in the closed-cell structure thereof.

FIG. 5 is a cross-sectional representation of the foam in which shaving preparation material is trapped between lamellae of the foam.

FIG. 6 is a side view of a razor assembly of the present invention incorporating the foam pad.

FIG. 7 is perspective view of a razor cartridge mounted in the foam pad.

FIG. 8 is a perspective view of the foam pad attached to a base.

### DETAILED DESCRIPTION OF THE PREFERRED EMBODIMENTS

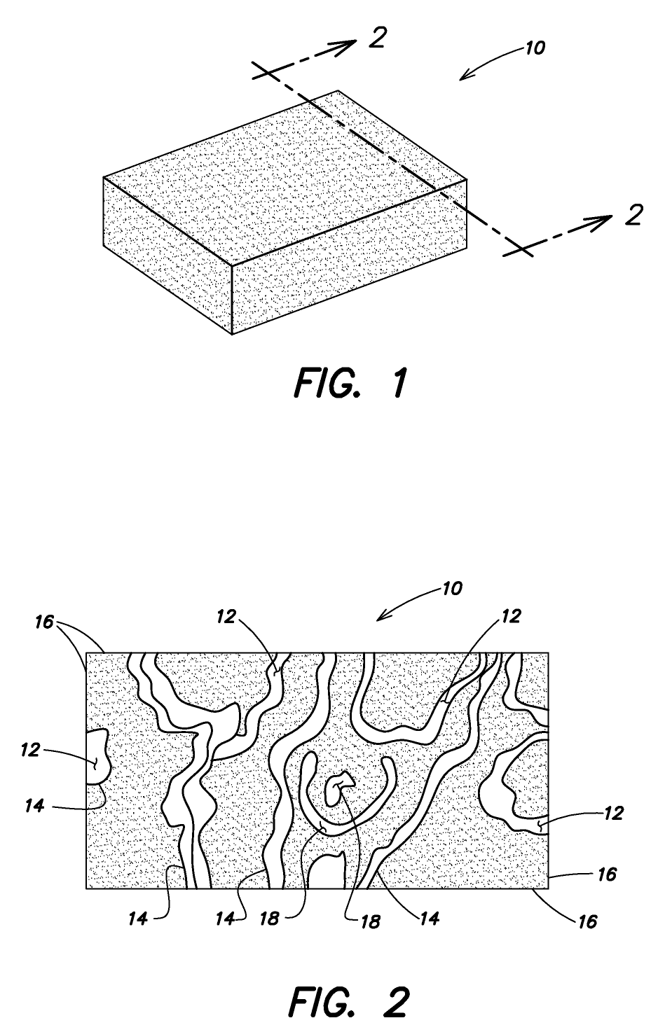

Referring to FIG. 1, a material useful for dispensing a shaving preparation is generally designated by the reference number 10 and is a foam and more preferably a nanofoam having a highly reticulated open-cell structure. As used herein, the term “nanofoam” should be broadly construed to mean foam materials having pore sizes in the nanometer range. As used herein, the term “open-cell” is intended to indicate a structure having a series of interconnected passageways that define a substantially open porosity. As used herein, “highly reticulated” is intended to indicate that the area defined by the cell walls is relatively small compared to the volume of the cells defined by the cell walls. In an open-cell foam structure, the open porosity allows fluid communication to be maintained from one boundary surface of the structure to the same or any other boundary surface of the structure. As will be explained in greater detail herein, the foam 10 is preferably non-erodable and is used in association with a razor cartridge in a wet shaving application. During a shaving operation, as the razor cartridge is drawn over a user's skin, the foam 10 is compressed causing the simultaneous deposition of shaving preparation onto the user's skin. The foam 10 may also take the form of a wipe, sponge, towel, or similar applicator device to apply shaving preparation material to a surface to be shaved or to dispense material such as, but not limited to, lotions onto a user's skin following a shaving operation.

Referring now to FIG. 2, the foam 10 is shown as having a series of interior tortuous paths 12 through which fluid can be transferred. The tortuous paths 12 are defined by walls or “struts 14” that form the cell structure. The tortuous paths 12 can extend from one boundary surface 16 of the foam 10 to the same or another boundary surface, or they can extend into the foam from a boundary surface and terminate within the foam. Some tortuous paths 12 may originate and terminate completely within the boundary surfaces 16 to form closed cells 18.

The struts 14 impart structure to the foam 10. In particular, the struts 14 forming the tortuous paths 12 can be collapsed upon themselves to allow the foam 10 to be compressed. Upon compression of the foam 10 (e.g., by the application of pressure when pressing the foam onto the surface being shaved), the collapse of the struts 14 reduces the volume of void space defined by some or all of the tortuous paths 12. As the volumes of the void spaces are reduced, fluid in the void spaces is forced along the tortuous paths 12 to areas of lower pressure. In general, the area of lower pressure is the area adjacent the boundary surfaces 16 outside the foam 10. In the preferred embodiments, the fluid in the void space is a shaving preparation material.

The material from which the foam 10 is fabricated is preferably a hydrophilic polyurethane. The foam is derived from a prepolymer liquid resin prepared from low molecular weight polyols and polyoxyethylene diols with an isocyanate, particularly toluene diisocyanate. The resulting resin is an alcohol having two or more free isocyanate groups. The free isocyanate groups are hydrolyzed, thereby releasing carbon dioxide gas, which foams the resin. The hydrolysis reaction products react with unhydrolyzed isocyanate to form a second reaction product that cross links with itself and stabilizes the foam structure. Excess water molecules trapped in the struts 14 impart the hydrophilic properties to the foam.

Upon manufacture, the foam may be mounted to release paper for transport or for storage until the foam is ready to be incorporated into a razor assembly or other shaving device and/or loaded with shaving preparation material. The foam may be mounted to the release paper by dropping the foam onto the paper or by molding the foam directly to the paper. The release paper may be a woven or non-woven material. The tack quality of the foam, particularly immediately after its fabrication, is generally sufficient to allow the release paper to be adhered to the foam.

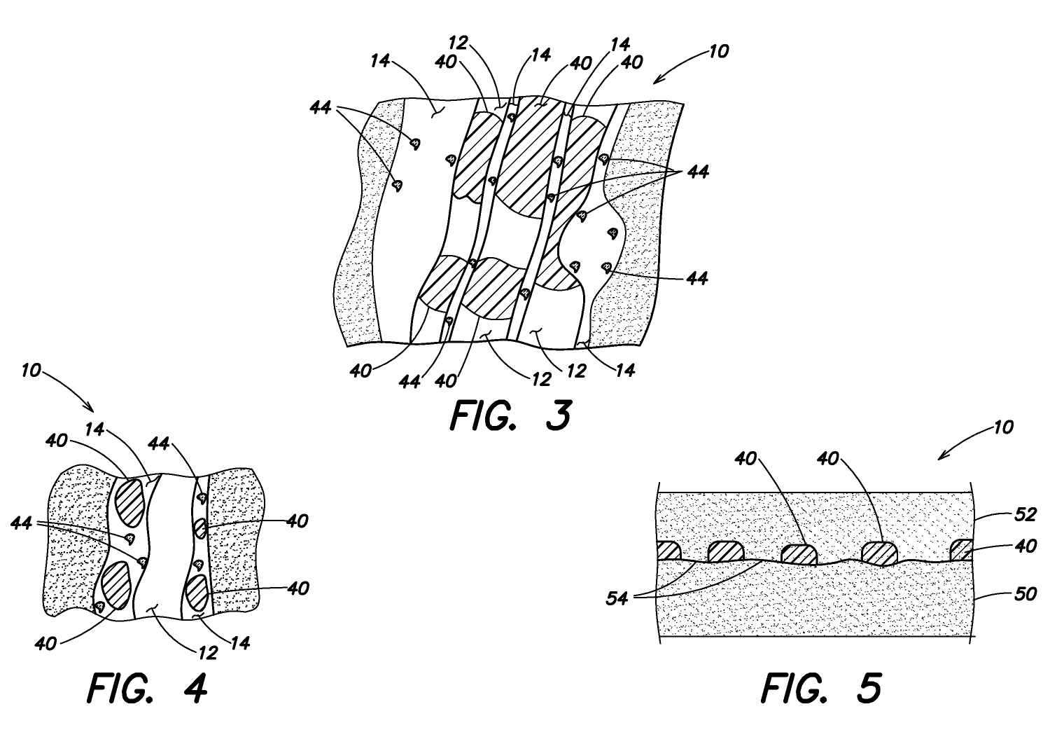

Referring now to FIGS. 3-5, shaving preparation materials that can be used with the foam 10 include, but are not limited to, lubricants, drag reducing agents, depilatory agents, cleaning agents, fillers, medicaments, hair softeners, skin-conditioners, vitamins, biocides, pharmaceuticals, humectants, surfactants, and the like. Fragrances and colorants may also be incorporated into the shaving preparation materials. Because of the tortuous nature of the substantially open-cell structure of the foam, outgassing of volatile components incorporated into the foam (e.g., menthol) is minimized. One preferred shaving preparation material that may be incorporated into the foam 10 is polyethylene oxide, which includes blends thereof in which various polyethylene oxides have different molecular weights.

When used with a wet-shave razor, the foam 10 provides a mechanism that yields a sustained release of shaving preparation onto a user's skin over an extended number of shaves. In one embodiment, as shown in FIG. 3, a particle of shaving preparation material is shown at 40 and is located in one of the tortuous paths 12 defined between the struts 14. Preferably, the shaving preparation material is water soluble. Surface tension of the particle 40 facilitates the retention of the particle in the foam 10. Upon use of the foam 10 in an aqueous environment, water molecules 44 trapped in the struts 14 migrate to the water of the aqueous environment, thereby solubilizing the particle 40 and facilitating the transport of the particle to the surface being shaved. Transport of the particle 40 is typically effected by a user squeezing the foam 10 or otherwise applying pressure to drive the water-solubilized particle 40 through the tortuous paths 12.

In another embodiment, as shown in FIG. 4, the particle 40 may be encapsulated directly within the struts 14 that define the tortuous paths 12. The particle 40 is trapped within the void spaces defined by the struts 14, i.e., within closed cell portions of the foam. Upon wetting with water, the particle 40 leaches from the closed cells through a hydrophilic membrane to the tortuous paths 12, which are in fluid communication with the aqueous environment. Once in the tortuous paths 12, the particle 40 is transported to the surface being shaved.

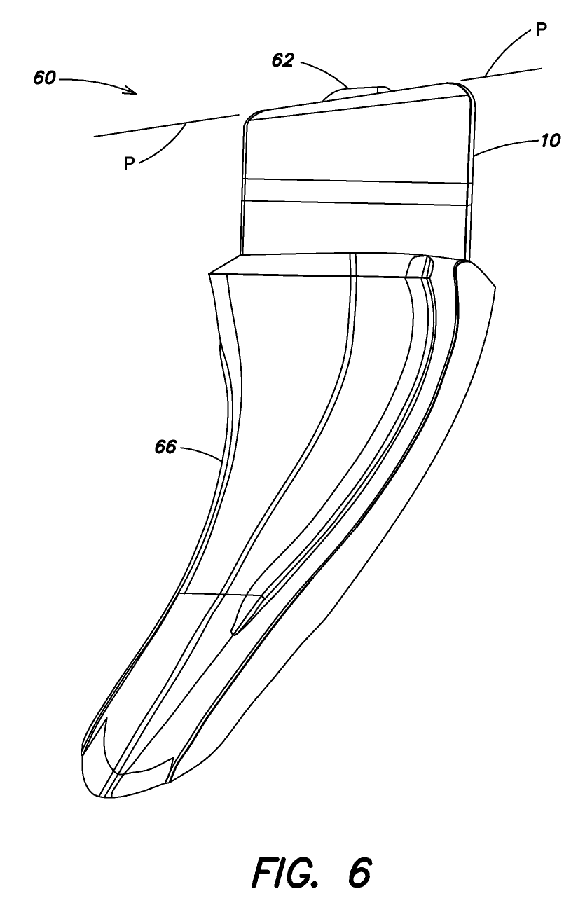

Referring now to FIG. 5, another embodiment is illustrated in which the particle 40 is incorporated directly into lamellae of the hydrophilic foam 10. In this embodiment, a substrate layer 50 of foam is used to provide a base layer on which particle 40 is deposited in discrete quantities. A second layer 52 of foam is then deposited over the particle 40 and the exposed portions of the substrate layer 50. Interfaces 54 are maintained between the substrate layer 50 and the second layer 52 to promote bonding between layers of the foam and to encapsulate the particle 40. As above, water molecules 44 are present in the foam to facilitate the transport of the particle 40 through the porosity of the foam to the surface being shaved.

The mechanisms for shaving preparation material transfer described with reference to FIGS. 3-5 can be used in foam individually or in combination. In any embodiment, the struts 14 that define the tortuous paths 12 increase the surface area over which the shaving preparation material contacts the water, which allows the water to permeate throughout the foam and release the shaving preparation material in a controlled manner.

Referring now to FIGS. 6-8, a razor assembly of the present invention is shown generally at 60 and includes a razor cartridge 62 and a handle 66. The razor cartridge 62 includes one or more razor blades 68 attached to a frame 70, each razor blade having a lengthwise extending cutting edge. In the illustrated embodiment, the foam 10 has been formed into a shaving preparation delivery system 71 that is mounted to the razor assembly 60.

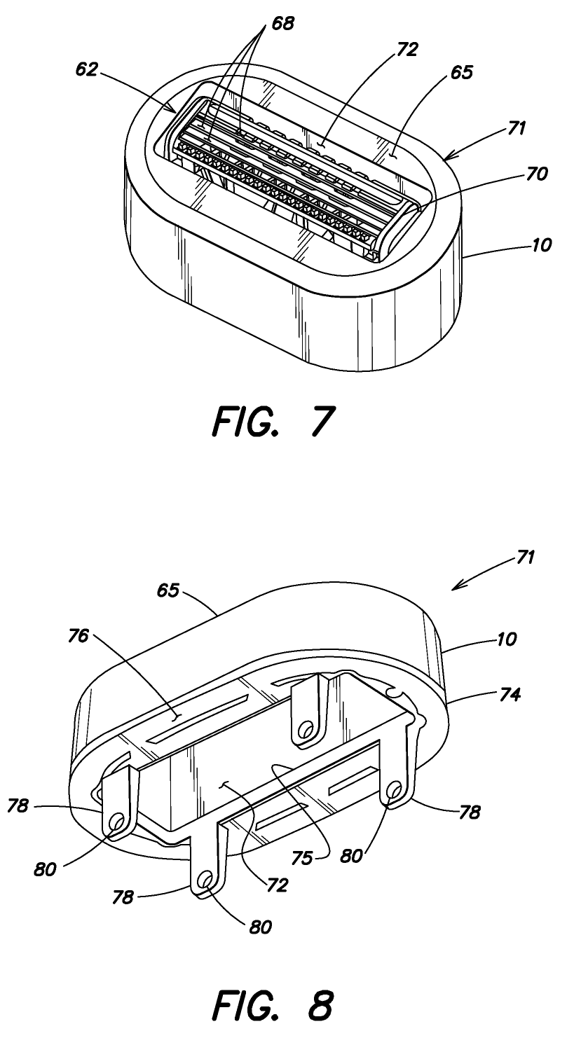

The foam 10 forming part of the shaving aid delivery system 71 includes the one or more shaving preparation materials (e.g., lubricants, drag reducing agents, depilatory agents, cleaning agents, fillers, medicaments, hair softeners, skin-conditioners, vitamins, biocides, pharmaceuticals, humectants, surfactants, and the like disposed therein) to enhance the shaving process. As is shown in FIGS. 7 and 8, the foam 10 of the shaving aid delivery system may be oval-shaped and define a central aperture 72 into which the razor cartridge 62 is received. An upper surface of the foam 10 defines a contact surface 65 that engages a user's skin during a shaving operation. In other embodiments, the foam 10 of the shaving aid delivery system 71 can comprise one or more discrete sections positioned adjacent the razor cartridge 62 such as, for example, a forward portion, an aft portion, and/or side portions.

Referring to FIG. 8, the shaving aid delivery system 71 can be mounted on a base 74 configured to support the foam. The foam 10 is attached to the base 74 by using, for example, insert forming, insert molding, bonding, mechanical features, adhesives, or the like. The base 74 includes an upper surface 75 on which the foam 10 is supported and a lower surface 76. The aperture 72 is central with an aperture extending through the center of the base 74. At least one mounting tab 78 extends from the lower surface of the base 74. Each mounting tab 78 has a hole 80. The holes 80 provide connection points for a linkage assembly in embodiments in which the razor cartridge is movable relative to the foam or provide points at which the base 74 may be anchored in the handle.

Referring to FIGS. 6-8, upon use of the razor assembly 60 in a shaving operation, the razor cartridge 62 (and thereby the razor blades 68) are brought into coincidence with the contact surface 65 of the foam 10 to define a shave plane P.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A razor assembly, comprising:
a handle;
a razor cartridge coupled to said handle and including one or more razor blades; and
a shaving preparation delivery system coupled to said handle and located adjacent to said razor cartridge, said shaving preparation delivery system comprising,
a hydrophilic foam member defining a contact surface for engaging a user's skin during a shaving operation, and
a water soluble shaving preparation material disposed in said hydrophilic foam member, so that during a shaving operation, pressure exerted on said hydrophilic foam member causes said shaving preparation to be dispelled from said contact surface onto the user's skin.

2. The razor assembly of claim 1, wherein said hydrophilic foam member comprises a nanofoam.

3. The razor assembly of claim 1, wherein said hydrophilic foam member has a cell structure selected from the group consisting of open-cell structures, closed-cell structures, and combinations of open-cell structures and closed-cell structures.

4. The razor assembly of claim 1, wherein said hydrophilic foam member is formed from a polyurethane foam.

5. The razor assembly of claim 4, wherein said polyurethane foam is derived from a prepolymer liquid resin prepared from a low molecular weight polyol, a polyoxyethylene diol, and toluene diisocyanate.

6. The razor assembly of claim 1, wherein said hydrophilic foam member includes entrapped water.

7. The razor assembly of claim 1, wherein said shaving preparation material is selected from the group consisting of lubricants, drag-reducing agents, depilatory agents, cleaning agents, fillers, medicaments, hair softeners, skin-conditioners, vitamins, biocides, pharmaceuticals, humectants, surfactants, fragrances, colorants, and combinations of the foregoing.

8. The razor assembly of claim 1, wherein said shaving preparation material is disposed between lamellae defined by said hydrophilic foam.

9. The razor assembly of claim 1, wherein said hydrophilic foam member surrounds said razor cartridge.

10. The razor assembly of claim 9, wherein said hydrophilic foam member defines a central aperture, said razor cartridge being receivable therein.

11. The razor assembly of claim 1, wherein said razor cartridge is movable relative to said hydrophilic foam member to cause said contact surface to remain substantially coincident with cutting edges defined by said razor blades during a shaving operation.

12. The razor assembly of claim 1, wherein said contact surface defined by said hydrophilic foam member is spaced-away from cutting edges defined by said razor blades so that during a shaving operation a user must press said hydrophilic foam against a surface being shaved to cause said cutting edges to engage the user's skin.

13. The razor assembly of claim 1, wherein said hydrophilic foam member has an oval-shaped cross section and a center aperture in which said razor cartridge is received.

14. A shaving device having a razor assembly, said shaving device comprising:
a handle;
a razor cartridge mounted in said handle;
a foam pad mounted adjacent to said razor cartridge, said foam pad comprising,
a hydrophilic foam defined by a plurality of struts that define tortuous paths, and
a shaving preparation material disposed in said tortuous paths, said shaving preparation material being a water-soluble material selectively dispensable from said foam in response to pressure applied to said foam;
wherein said razor cartridge is movable relative to a contact surface of said foam pad.

15. The shaving device of claim 14, wherein said hydrophilic foam is a nanofoam.

16. The shaving device of claim 14, wherein said hydrophilic foam is a polyurethane foam derived from a prepolymer liquid resin prepared from a low molecular weight polyol, a polyoxyethylene diol, and toluene diisocyanate.

17. The shaving device of claim 14, wherein said shaving preparation material is selected from the group consisting of lubricants, drag-reducing agents, depilatory agents, cleaning agents, fillers, medicaments, hair softeners, skin-conditioners, vitamins, biocides, pharmaceuticals, humectants, surfactants, fragrances, colorants, and combinations of the foregoing.

18. A shaving preparation delivery system, comprising:
a foam pad having a central aperture and a contact surface, said foam pad being mountable on one of a base and a handle, said central aperture being sized to received a razor cartridge therein; and
a water soluble shaving preparation material disposed in said foam pad such that during a shaving operation, pressure exerted on said foam pad causes said shaving preparation to be dispelled from said contact surface onto a user's skin.

19. The shaving preparation delivery system of claim 18, wherein said foam pad is a hydrophilic foam member comprising a nanofoam.

20. The shaving preparation delivery system of claim 18, wherein said foam pad has a cell structure selected from the group consisting of open-cell structures, closed-cell structures, and combinations of open-cell structures and closed-cell structures.

21. The shaving preparation delivery system of claim 18, wherein said foam pad is a polyurethane foam derived from a prepolymer liquid resin prepared from a low molecular weight polyol, a polyoxyethylene diol, and toluene diisocyanate.

22. The shaving preparation delivery system of claim 18, wherein said shaving preparation material is selected from the group consisting of lubricants, drag-reducing agents, depilatory agents, cleaning agents, fillers, medicaments, hair softeners, skin-conditioners, vitamins, biocides, pharmaceuticals, humectants, surfactants, fragrances, colorants, and combinations of the foregoing.
